(19) United States
(12) Patent Application Publication
(10) Pub. No.: US 2026/0106292 A1
(43) Pub. Date: Apr. 16, 2026

(54) BATTERY CASING SEALING DEVICE, BATTERY CASING, AND BATTERY PACK

(71) Applicant: SAMSUNG SDI CO., LTD., Yongin-si (KR)

(72) Inventor: Sanghun PARK, Yongin-si (KR)

(21) Appl. No.: 19/356,452

(22) Filed: Oct. 13, 2025

(30) Foreign Application Priority Data
Oct. 14, 2024 (KR) 10-2024-0139888

(51) Int. Cl. H01M 50/24; H01M 50/204; H01M 50/262; H01M 50/271

(52) U.S. Cl. CPC H01M 50/24; H01M 50/204; H01M 50/262; H01M 50/271

(57) ABSTRACT

Disclosed herein are a battery casing sealing device, a battery casing, and a battery pack. The battery casing sealing device is configured to seal a joint between a first casing and a second casing of a battery casing. The battery casing sealing device includes a first elastic member fixed configured to be fixed to an upper end of a rib of the first casing located at the joint, and a second elastic member fixed to a lower end of the rib of the first casing located at the joint and configured to contact a bottom surface of a groove of the second casing into which the rib of the first casing is inserted.

The present application claims priority to and the benefit of Korean Patent Application No. 10-2024-0139888 filed on Oct. 14, 2025, in the Korean Intellectual Property Office, the entire disclosure of which is incorporated herein by reference.

### BACKGROUND

### 1. Technical Field

The present disclosure relates to a battery casing sealing device, a battery casing, and a battery pack, and more particularly, to a battery casing sealing device provided at a joint between a first casing and a second casing constituting a battery casing, a battery casing, and a battery pack.

### 2. Related Art

Unlike primary batteries that are not designed to be charged, secondary batteries can be discharged and recharged. Low-capacity secondary batteries are used in small portable electronic devices, such as smart phones, feature phones, notebook computers, digital cameras, and camcorders. Large-capacity secondary batteries are widely used as power sources for driving motors, such as of hybrid vehicles or electric vehicles, and for power storage. A secondary battery includes an electrode assembly comprising a positive electrode and a negative electrode, a case that accommodates the electrode assembly, and a terminal part connected to the electrode assembly.

For a battery pack including multiple secondary batteries, a typical casing is constituted of two or more parts, which are made of plastic material with good formability and connected to each other by means of a plurality of fasteners to protect a plurality of battery cells housed in the casing. A battery casing is waterproof and dustproof. To be waterproof and dustproof, a sealing member is inserted into regions that need to be kept airtight. However, such sealing member may be prone to failure depending on its size, the state of fastening to the casing, or the like.

The information disclosed in this section is for enhancement of understanding of the background of the present disclosure and may contain information that does not constitute related or prior art.

### SUMMARY

An object of the present disclosure is to provide a battery casing sealing device provided at a joint between a first casing and a second casing constituting a battery casing, a battery casing, and a battery pack.

However, the technical problems to be solved by the present disclosure is not limited to the above-described problems. Other problems not mentioned herein, and aspects and features of the present disclosure that would address such problems, will be clearly understood by those skilled in the art from the description of the present disclosure below.

In accordance with an aspect of the present disclosure, there is provided a battery casing sealing device configured to seal a joint between a first casing and a second casing of a battery casing. The battery casing sealing device includes a first elastic member configured to be fixed to an upper end of a rib of the first casing located at the joint, and a second elastic member configured to be fixed to a lower end of the rib of the first casing located at the joint and configured to contact a bottom surface of a groove of the second casing into which the rib of the first casing is inserted.

The battery casing sealing device may further include a connection member connecting the first elastic member and the second elastic member.

The battery casing sealing device may further include an extension part extending from the second elastic member to contact a side of the groove of the second casing.

The first elastic member may be configured to be fixed to a fastening groove formed in the upper end of the rib of the first casing.

The second elastic member may be configured to be fixed to a second fastening groove formed oi the lower end of the rib of the first casing.

At least one of the first elastic member and the second elastic member may have a circular cross-section.

at least one of the first elastic member and the second elastic member may have a curve shaped cross-section.

In accordance with another aspect of the present disclosure, there is provided a battery casing configured to house a plurality of battery cells. The battery casing includes a first casing, a second casing coupled to the first casing, and a battery casing sealing device provided at a joint between the first casing and the second casing, wherein the battery casing sealing device includes a first elastic member fixed to an upper end of a rib of the first casing located at the joint, and a second elastic member fixed to a lower end of the rib of the first casing located at the joint and contacting a bottom surface of a groove of the second casing into which the rib of the first casing is inserted.

The battery casing sealing device may further include a connection member connecting the first elastic member and the second elastic member.

The battery casing sealing device may further include an extension part extending from the second elastic member and contacting a side of the groove of the second casing.

A fastening groove may be formed in the upper end of the first casing, and the first elastic member may be fixed to the fastening groove.

A fastening groove may be formed in the lower end of the rib of the first casing, and the second elastic member may be fixed to the fastening groove.

at least one of the first elastic member and the second elastic member may have a circular cross-section.

at least one of the first elastic member and the second elastic member may have a curved shaped cross-section.

In accordance with a further aspect of the present disclosure, there is provided a battery pack that includes a plurality of battery cells, and a battery casing housing the plurality of battery cells and including a first casing, a second casing coupled to the first casing, and a battery casing sealing device provided at a joint between the first casing and the second casing, wherein the battery casing sealing device includes a first elastic member fixed to an upper end of a rib of the first casing located at the joint, and a second elastic member fixed to a lower end of the rib of the first casing located at the joint and contacting a bottom surface of a groove of the second casing into which the rib of the first casing is inserted.

The battery casing sealing device may further include a connection member connecting the first elastic member and the second elastic member.

The battery casing sealing device may further include an extension part extending from the second elastic member and contacting a side of the groove of the second casing.

A fastening groove may be formed in the upper end of the rib of the first casing, and the first elastic member may be fixed to the first fastening groove.

A fastening groove may be formed in the lower end of the rib of the first casing, and the second elastic member may be fixed to the fastening groove.

At least one of the first elastic member and the second elastic member may have a circular cross-section.

However, aspects and features of the present disclosure are not limited to those described above, and other aspects and features not mentioned will be clearly understood by a person skilled in the art from the detailed description below.

### BRIEF DESCRIPTION OF THE DRAWINGS

The accompanying drawings illustrate preferred embodiments of the present disclosure and serve to further describe aspects and features of the present disclosure together with the detailed description of the present disclosure. The present disclosure should not be construed as being limited to the drawings.

FIG. 1 is a schematic view of a cylindrical lithium secondary battery according to an embodiment;

FIG. 2 is a schematic view of a prismatic lithium secondary battery according to an embodiment;

FIGS. 3 and 4 are schematic views of a pouch-type lithium secondary battery according to an embodiment;

FIGS. 5A and 5B are views of a conventional battery casing;

FIGS. 6A to 6D are cross-sectional views of a joint between a first casing and a second casing of the conventional battery casing;

FIG. 7 is a cross-sectional view of a state in which a battery casing sealing device is coupled to a battery casing according to an embodiment of the present disclosure;

FIG. 8 is a perspective view of a portion of the battery casing sealing device according to the embodiment of the present disclosure; and

FIG. 9 is a cross-sectional view of a state before the battery casing sealing device is coupled to the battery casing according to the embodiment of the present disclosure.

### DETAILED DESCRIPTION

Exemplary embodiments of the present disclosure will be described below in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own invention in the best way possible. Accordingly, since the embodiments described in this specification and the configurations illustrated in the drawings are only an example of the present disclosure and they do not cover all the technical ideas of the present disclosure, various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

To facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

Secondary batteries can be a coin type, a cylindrical type, a prismatic type, and a pouch type. Before descriptions of embodiments of the present disclosure, cylindrical, pouch type, and prismatic secondary batteries are described because the present disclosure may be applied to such types of secondary batteries.

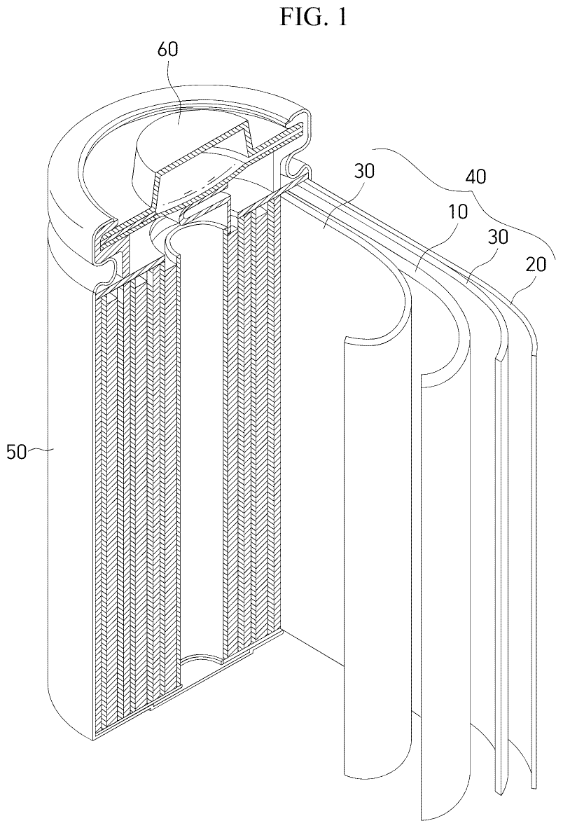

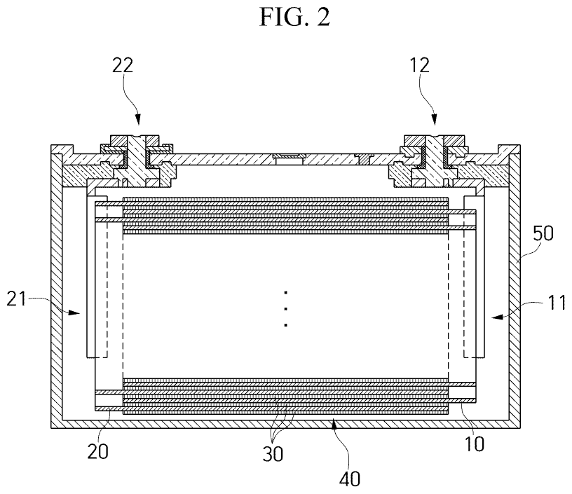

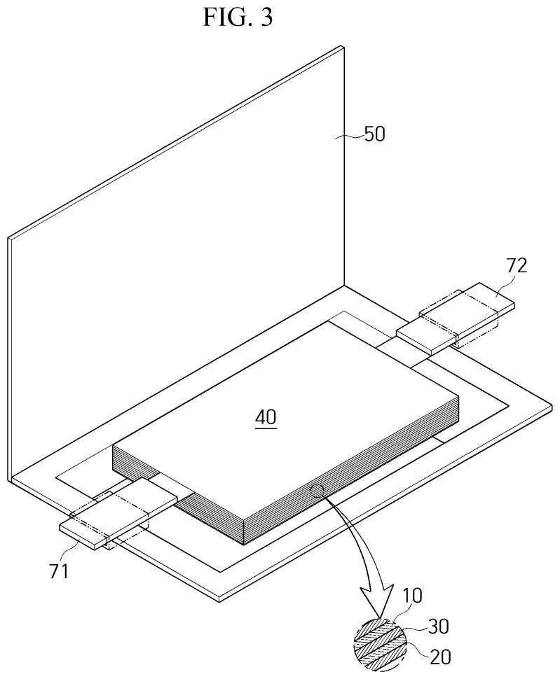

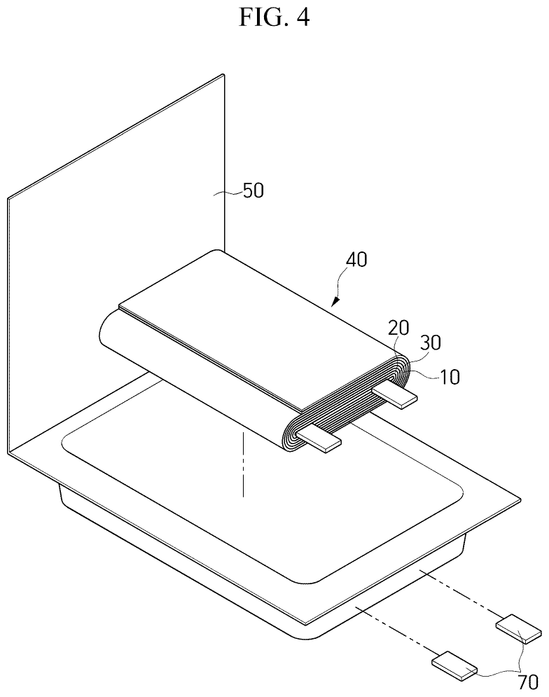

FIGS. 1 to 4 are schematic diagrams of lithium secondary batteries according to examples of the present disclosure. FIG. 1 illustrates a cylindrical lithium secondary battery. FIG. 2 illustrates a prismatic type secondary battery. FIGS. 3 and 4 illustrate a pouch type secondary battery. Referring to FIG. 1 to 4, a lithium secondary battery 1 may include an electrode assembly 40 in which a separator 30 is interposed between a first electrode plate 10 and a second electrode plate 20. The electrode assembly 40 is accommodated in a case 50. The first electrode plate 10, the second electrode plate 20, and the separator 30 may be impregnated with an electrolyte (not illustrated). As illustrated in FIG. 1, the lithium secondary battery 1 may include a sealing member 60 that seals the case 50. In FIG. 2, the lithium secondary battery 1 includes a first electrode lead tab 11, a first electrode terminal 12, a second electrode lead tab 21, and a second electrode terminal 22. As illustrated in FIGS. 3 and 4, the lithium secondary battery 1 includes an electrode tab 70 that provides an electrical passage for inducing a current formed in the electrode assembly 40 to outside of the electrode assembly 40, that is, a first electrode tab 71 and a second electrode tab 72.

The electrode assembly 40 may be formed by winding or stacking the first electrode plate 10, the second electrode plate 20, and the separator 30, each of which is formed in a plate or film shape. For a winding stack, the winding axis of the electrode assembly 40 may be parallel to the length direction of the case. In other examples, the electrode assembly 40 may be the stack type, but the shape of the electrode assembly 40 is not limited in the present disclosure. The first electrode plate 10 of the electrode assembly 40 may function as a positive electrode, and the second electrode plate 20 functions as a negative electrode, or vice versa.

The first electrode plate 10 may be formed by applying a first electrode active material, such as graphite or carbon, to a first electrode collector plate formed of metal foil, such as copper, a copper alloy, nickel, or a nickel alloy. The first electrode plate 10 may include a first electrode tab (or a first uncoated part), which is an area where no first electrode active material is provided.

The second electrode plate 20 may be formed by applying a second electrode active material, such as transition metal oxide, to a material formed of metal foil, such as aluminum or an aluminum alloy. The second electrode plate 20 may include a second electrode tab (or a second uncoated part), which is an area where the second electrode active material is not provided.

The separator 30 may function to prevent a short-circuit between the first electrode plate 10 and the second electrode plate 20 while permitting movement of lithium ions between the plates 10 and 20. The separator 30 may be, for example, a polyethylene film, a polypropylene film, or a polyethylene-polypropylene film.

The secondary batteries described above may be provided in a plurality to constitute a plurality of battery cells, which may be housed in a battery casing to constitute a battery pack.

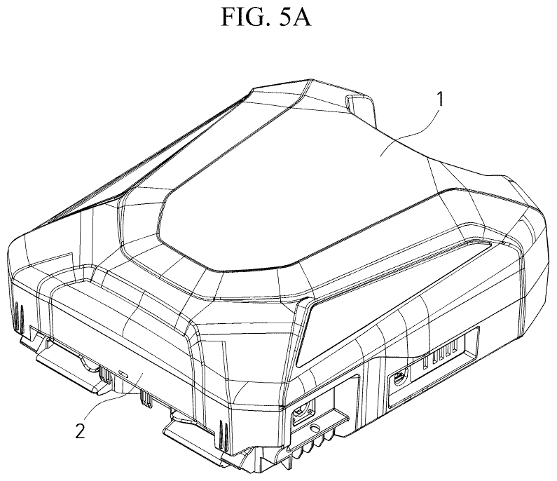

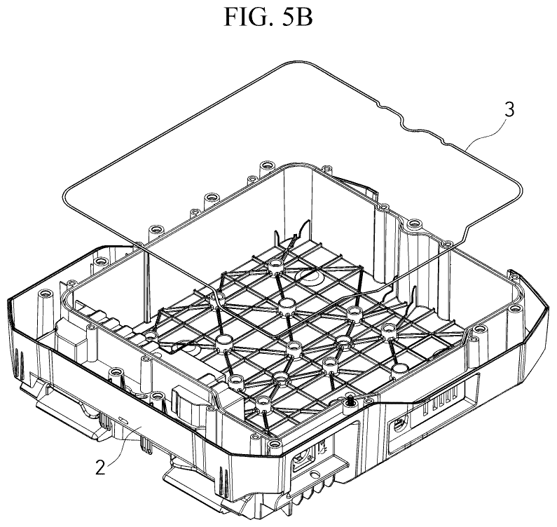

FIGS. 5A and 5B are views of a conventional battery casing.

Referring to FIGS. 5A and 5B, the battery casing includes a first casing 1 and a second casing 2 as illustrated in FIG. 5A. The second casing 2 is provided with a battery management system (BMS), and a plurality of battery cells are provided in the second casing 2. Screws may be used for joining of the battery casing, coupling of the BMS, or the like.

A standard battery casing is waterproof and dustproof. To be waterproof and dustproof, a sealing member 3 is inserted into a region that needs to be kept airtight, as is illustrated in FIG. 5B. However, this sealing member may be prone to failure depending on its size, the state of fastening to the casing, or the like.

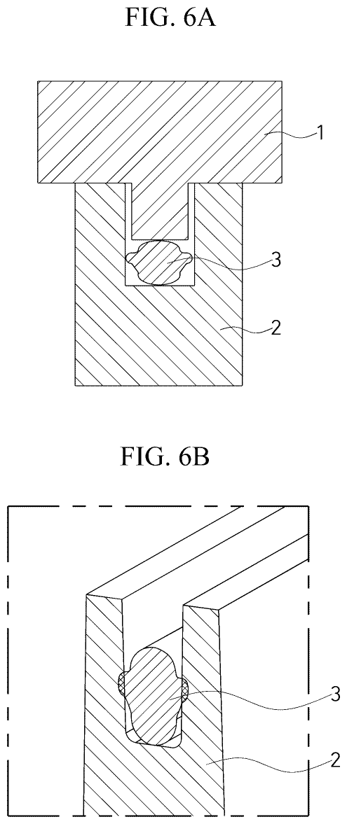

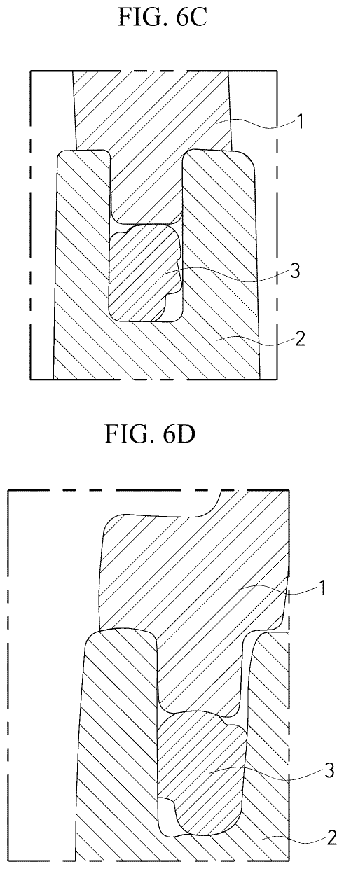

FIGS. 6A to 6D are cross-sectional views illustrating a joint between the first casing and the second casing of the conventional battery casing.

Referring to FIGS. 6A to 6D, the sealing member 3 may be inserted into the joint between the first casing 1 and the second casing 2 as illustrated in FIG. 6A. If the sealing member 3 and the groove of the second casing 2 are properly sized to seat the sealing member 3 in the groove of the second casing 2 as illustrated in FIG. 6B, a desired sealing effect can be obtained. However, if the sealing member 3 is larger than the groove of the second casing 2, the sealing member may not be properly seated, as is illustrated in FIGS. 6C and 6D. Such a situation results in a reduced sealing effect, and, thus, an inability to maintain airtightness. In other words, in the conventional sealing method using the sealing member 3, a sealing force depends on the size of the sealing member, the state in which the sealing member is seated in the casing, the state in which the casing is fastened, etc., because the sealing member 3 is compressed by means of the pressure caused by the vertical fastening of the first casing 1 and the second casing 2. Hence, the large size of the sealing member 3 or the poor seating of the first casing 1 and the second casing 2 may directly lead to sealing failure.

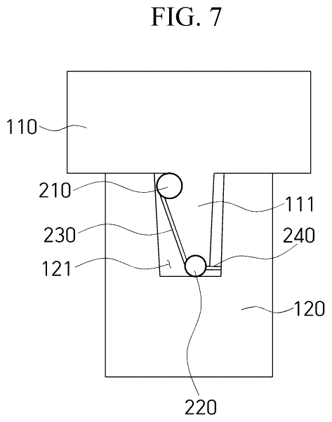

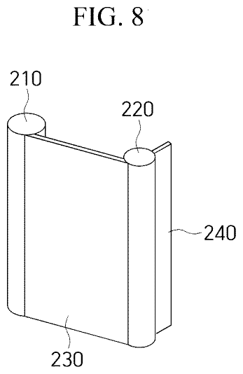

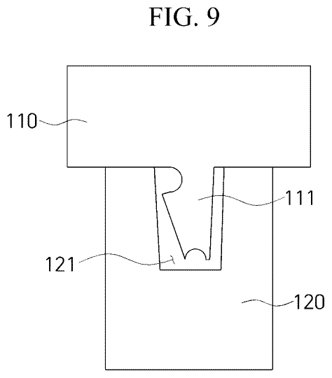

FIG. 7 is a cross-sectional view of a state of a battery casing sealing device coupled to a battery casing according to an embodiment of the present disclosure. FIG. 8 is a perspective view of a portion of the battery casing sealing device according to the embodiment of the present disclosure. FIG. 9 is a cross-sectional view of a state before the battery casing sealing device is coupled to the battery casing according to the embodiment of the present disclosure.

Referring to FIG. 7, the battery casing sealing device is provided at a joint between a first casing 110 and a second casing 120 constituting a battery casing. Referring to FIGS. 7 and 8, the battery casing sealing device may include a first elastic member 210, a second elastic member 220, a connection member 230, and an extension part 240. FIG. 8 illustrates a part of the battery casing sealing device. The battery casing sealing device may be implemented by corresponding to the shape of the joint between the first casing 110 and the second casing 120. For example, the battery casing sealing device may be of the same size as the sealing member 3 in FIG. 5B.

The first elastic member 210 is fixed to the upper end of the rib 111 of the first casing 110 located at the joint between the first casing 110 and the second casing 120. In an embodiment, the first elastic member 210 may be fastened and fixed to a first fastening groove formed on the upper end of the rib 111 of the first casing 110. As illustrated in FIG. 9, because the first fastening groove is formed on the upper end of the rib 111 of the first casing 110, the first elastic member 210 may be fastened and fixed thereto. The first fastening groove may prevent the rolling of the first elastic member 210. The first elastic member 210 may be in contact with the side of the groove 121 of the second casing 120 to create an elastic force toward the center of the joint between the first casing 110 and the second casing 120, thereby increasing sealing force provided by the sealing device.

In an embodiment, the first elastic member 210 may be circular in cross-section, as illustrated in FIG. 7. In another embodiment, the first elastic member 210 may be of a partially curved shape in cross-section. The cross-section of the first elastic member 210 may have different shapes. However, to maximize the elastic sealing force, it is preferable that the first elastic member 210 be curved at the portion that contacts the groove 121 of the second casing 120.

The second elastic member 220 is fixed to the lower end of the rib 111 of the first casing 110 located at the joint between the first casing 110 and the second casing 120. The second elastic member 220 contacts the bottom surface of the groove 121 of the second casing 120 into which the rib 111 of the first casing 110 is inserted. In an embodiment, the second elastic member 220 may be fastened and fixed to a second fastening groove formed on the lower end of the rib 111 of the first casing 110. As illustrated in FIG. 9, because the second fastening groove is formed on the lower end of the rib 111 of the first casing 110, the second elastic member 220 may be fastened and fixed thereto. The second fastening groove may prevent the rolling of the second elastic member 220. The second elastic member 220 may be in contact with the bottom surface of the groove 121 of the second casing 120 to create an elastic force toward the center of the joint between the first casing 110 and the second casing 120, thereby increasing a sealing force.

In an embodiment, the second elastic member 220 may be circular in cross-section, as illustrated in FIG. 7. In another embodiment, the second elastic member 220 may be of a partially curved shape in cross-section. The cross-section of the second elastic member 220 may have different shapes. However, to maximize the elastic sealing force, it is preferable that the second elastic member 220 be curved at the portion that contacts the groove 121 of the second casing 120.

The connection member 230 connects the first elastic member 210 and the second elastic member 220. The connection member 230 may improve the workability of fastening between the first and second elastic members 210 and 220 and the first casing 110 and to preserve the shape between the first and second elastic members 210 and 220. The connection member 230 may be made of the same elastic material as the first elastic member 210 and the second elastic member 220.

The extension part 240 extends from the second elastic member 220 to contact the side of the groove 121 of the second casing 120. The extension part 240 may contact the side of the groove 121 of the second casing 120 to create an elastic force toward the center of the joint between the first casing 110 and the second casing 120, thereby preventing the rolling of the second elastic member 220 during fastening of the first casing 110 and the second casing 120 and preventing separation between the first casing 110 and the second casing 120.

The battery casing sealing device according to an embodiment of the present disclosure described with reference to FIGS. 7 to 9 is fastened and fixed to the rib 111 of the first casing 110 in a manner analogous to putting a thimble on the rib 111. The first casing 110 and the second casing 120 are thereby vertically fastened and combined.

According to embodiments of the present disclosure, the battery casing sealing device provided at the joint between the first casing 110 and the second casing 120 is composed of the elastic members 210 and 220 and is fixed to the rib 111 of the first casing 110. The battery casing sealing device thereby enables the rib 111 of the first casing 110 to be seated on the groove 121 of the second casing 120 to stably maintain a posture after the first casing 110 and the second casing 120 are brought together.

According to embodiments of the present disclosure, the battery casing sealing device is composed of two elastic members 210 and 220 connected to each other, and each of the elastic members 210 and 220 is fixed to the rib 111 of the first casing 110. The battery casing sealing device thereby ensures two sealing points to improve the sealing force.

Hereinafter, materials that may be used in a secondary battery according to an embodiment of the present disclosure are described.

A compound (e.g., a lithiated intercalation compound) capable of reversible intercalation and deintercalation of lithium may be used as a positive electrode active material. Specifically, one or more of complex oxides of metal, selected among cobalt, manganese, nickel, and a combination of them, and lithium may be used as the positive electrode active material.

The complex oxide may be lithium transition metal complex oxide. Examples of the complex oxide include lithium nickel-based oxide, lithium cobalt-based oxide, lithium manganese-based oxide, a lithium ferrous phosphate-based compound, cobalt-free nickel-manganese-based oxide, and combinations of these compounds. A compound that is represented by one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹ _{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8). In these chemical formulas, A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination thereof; and L¹ may be Mn, Al, or a combination thereof.

A positive electrode for a lithium secondary battery may include a current collector and a positive electrode active material layer formed on the current collector. The positive electrode active material layer may include the positive electrode active material and may further include a binder and/or a conductive material.

The amount of the positive electrode active material may be 90 wt. % to 99.5 wt. % with respect to 100 wt. % of the positive electrode active material layer. The amount of the binder and the conductive material may be 0.5 wt. % to 5 wt. % with respect to 100 wt. % of the positive electrode active material layer.

Aluminum may be used as the current collector. But the present disclosure is not limited thereto.

A negative electrode active material may include a material capable of reversibly intercalation/de-intercalation of lithium ions, lithium metal, an alloy of lithium metal, a material capable of doping and dedoping with respect to lithium, or transition metal oxide.

The material capable of reversibly Intercalation/de-intercalation of lithium ions may include a carbon-based negative electrode active material, for example, crystalline carbon, amorphous carbon, or a combination thereof. An example of the crystalline carbon is graphite, such as natural graphite or synthetic graphite. Examples of the amorphous carbon include soft or hard carbon, mesophase pitch carbide, and fired coke.

An Si-based negative electrode active material or an Sn-based negative electrode active material may be used as the material capable of doping and dedoping of lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to an example, the silicon-carbon composite may include silicon particles, and may have a form in which amorphous carbon is coated on surfaces of silicon particles.

The silicon-carbon composite may further include crystalline carbon. For example, the silicon-carbon composite may include a core including crystalline carbon and silicon particles and an amorphous carbon coating layer disposed on a surface of the core.

A negative electrode for a lithium secondary battery may include a current collector and a negative electrode active material layer disposed on the current collector. The negative electrode active material layer may include the negative electrode active material and may further include a binder and/or a conductive material. For example, the negative electrode active material layer may include 90 wt. % to 99 wt. % of the negative electrode active material, 0.5 wt. % to 5 wt. % of the binder, and 0 wt. % to 5 wt. % the conductive material.

A nonaqueous-based binder, an aqueous-based binder, a dry binder, or a combination thereof may be used as the binder. If the aqueous-based binder is used as a binder for the negative electrode, the binder for the negative electrode may further include a cellulose-series compound capable of assigning viscosity.

One of nickel foil, stainless steel foil, titanium foil, nickel foam, copper foam, a polymer base on which a conductive metal has been coated, and a combination thereof may be used as a current collector for the negative electrode.

An electrolyte for a lithium secondary battery may include a nonaqueous organic solvent and lithium salts. The nonaqueous organic solvent may be a medium through which ions that are involved in an electrochemical reaction of a battery can move. The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of these may be mixed and used as the nonaqueous organic solvent. If the carbonate-based solvent is used, annular carbonate and chain carbonate may be mixed and used.

A separator may be provided between the positive electrode and the negative electrode depending on the type of lithium secondary battery. Polyethylene, polypropylene, and polyvinylidene fluoride, or a multi-layer having two or more layers of them may be used as the separator. The separator may include a porous base, and a coating layer including an organic matter, an inorganic matter, or a combination thereof that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited to these examples.

The organic matter and the inorganic matter may have a form in which the organic matter and the inorganic matter are mixed in one coating layer. In other examples, a coating layer including the organic matter and a coating layer including the inorganic matter are stacked.

Although the present disclosure has been described above in connection with the embodiments and drawings, the present disclosure is not limited to the embodiments. A person having ordinary knowledge in the art to which the present disclosure pertains may modify and change the present disclosure within the technical spirit of the present disclosure.

What is claimed is:

1. A battery casing sealing device configured to seal a joint between a first casing and a second casing of a battery casing, the battery casing sealing device comprising:
a first elastic member configured to be fixed to an upper end of a rib of the first casing located at the joint; and
a second elastic member configured to be fixed to a lower end of the rib of the first casing located at the joint and configured to contact a bottom surface of a groove of the second casing into which the rib of the first casing is inserted.

2. The battery casing sealing device as claimed in claim 1, further comprising a connection member connecting the first elastic member and the second elastic member.

3. The battery casing sealing device as claimed in claim 1, further comprising an extension part extending from the second elastic member to contact a side of the groove of the second casing.

4. The battery casing sealing device as claimed in claim 1, wherein the first elastic member is configured to be fixed to a fastening groove formed in the upper end of the rib of the first casing.

5. The battery casing sealing device as claimed in claim 1, wherein the second elastic member is configured to be fixed to a fastening groove formed in the lower end of the rib of the first casing.

6. The battery casing sealing device as claimed in claim 1, wherein at least one of the first elastic member and the second elastic member has a circular cross-section.

7. The battery casing sealing device as claimed in claim 1, wherein at least one of the first elastic member and the second elastic member has a curve shaped cross-section.

8. A battery casing configured to house a plurality of battery cells,
a first casing;
a second casing coupled to the first casing; and
a battery casing sealing device provided at a joint between the first casing and the second casing,
wherein the battery casing sealing device comprises:
a first elastic member fixed to an upper end of a rib of the first casing located at the joint, and
a second elastic member fixed to a lower end of the rib of the first casing located at the joint and contacting a bottom surface of a groove of the second casing into which the rib of the first casing is inserted.

9. The battery casing as claimed in claim 8, wherein the battery casing sealing device further comprises a connection member connecting the first elastic member and the second elastic member.

10. The battery casing as claimed in claim 8, wherein the battery casing sealing device further comprises an extension part extending from the second elastic member and contacting a side of the groove of the second casing.

11. The battery casing as claimed in claim 8, wherein a fastening groove is formed in the upper end of the rib of the first casing, and the first elastic member is fixed to the fastening groove.

12. The battery casing as claimed in claim 8, wherein a fastening groove is formed in the lower end of the rib of the first casing, and the second elastic member is fixed to the fastening groove.

13. The battery casing as claimed in claim 8, wherein at least one of the first elastic member and the second elastic member has a circular cross-section.

14. The battery casing as claimed in claim 8, wherein at least one of the first elastic member and the second elastic member has a curve shaped cross-section.

15. A battery pack comprising:
a plurality of battery cells; and
a battery casing configured housing the plurality of battery cells and comprising a first casing, a second casing coupled to the first casing, and a battery casing sealing device provided at a joint between the first casing and the second casing,
wherein the battery casing sealing device comprises a first elastic member fixed to an upper end of a rib of the first casing located at the joint, and a second elastic member fixed to a lower end of the rib of the first casing located at the joint and contacting a bottom surface of a groove of the second casing into which the rib of the first casing is inserted.

16. The battery pack as claimed in claim 15, wherein the battery casing sealing device further comprises a connection member connecting the first elastic member and the second elastic member.

17. The battery pack as claimed in claim 15, wherein the battery casing sealing device further comprises an extension part extending from the second elastic member and contacting a side of the groove of the second casing.

18. The battery pack as claimed in claim 15, wherein a fastening groove is formed in the upper end of the rib of the first casing, and the first elastic member is fixed to the fastening groove.

19. The battery pack as claimed in claim 15, wherein a fastening groove is formed in the lower end of the rib of the first casing, and the second elastic member is fixed to the fastening groove.

20. The battery pack as claimed in claim 15, wherein at least one of the first elastic member and the second elastic member has a circular cross-section.
